(19) United States
(12) Patent Application Publication
(10) Pub. No.: US 2022/0197460 A1
(43) Pub. Date: Jun. 23, 2022

(54) SELECTING ITEMS ON A VEHICLE TOUCH SCREEN

(71) Applicant: THOUGHT WORKS SOFTWARE TECHNOLOGY (BEIJING) LIMITED CO., Dongcheng District Beijing (CN)

(72) Inventor: Chen ZHU, Hi-Tech Development District Xi'an, Shaa (CN)

(21) Appl. No.: 17/441,925

(22) PCT Filed: Jul. 26, 2019
(86) PCT No.: PCT/CN2019/097867

§ 371 Date: Sep. 22, 2021

(30) Foreign Application Priority Data
Mar. 22, 2019 (CN) 201910222824.6

(51) Int. Cl. G06F 3/0488; G06F 3/04842; G06F 3/16; B60K 35/00

(52) U.S. Cl. CPC G06F 3/0488; G06F 3/04842; G06F 3/167; B60K 2370/1472; B60K 2370/1438; B60K 2370/1575; B60K 35/00

(57) ABSTRACT

Methods and systems for selecting an item on a vehicle touch screen are provided. In one embodiment, a method is provided that includes determining an initial touch position of an external touch position and an option selection control and an initial option selection of the option selection control corresponding to the initial touch position. The method may then include detecting a current touch position and a movement trajectory of the external touch operation and a focused option corresponding thereto. Upon detecting a termination of the external touch operation, a final disengagement location may be determined and a final selection may be determined based on the initial touch position, the final disengagement position, and the movement trajectory.

### TECHNICAL FIELD

The present invention relates to the technical field of motor vehicles, and in particular to a method for selecting an item based on a vehicle touch screen and a vehicle touch screen implementing the same.

### BACKGROUND

Drivers may regularly need to select options for various parameters while operating a vehicle. For example, a driver may need to select between options for the vehicle's climate control system or may need to select a chassis suspension mode. Conventionally, motor vehicles may include physical controls, such as a set of buttons, for making these selections, and drivers can press one of a plurality of buttons to make their selection. When using physical controls, drivers and other users can manipulate selections without having to look at the control for too long. For example, a driver may rely on touch to find the control, operate it, determine completion of a selection operation, and confirm that a desired selection option has been achieved. However, physical controls have disadvantages. For example, once installed, the shape and function of these controls cannot be easily changed, and cockpit space of the vehicle is always occupied by the controls, regardless of whether the driver is using the controls. More recent vehicle cockpits replace these physical controls with a multi-touch LCD screens (hereinafter referred to as touch screens). Using such touch screens as controls allows for the displayed content to be flexibly changed as needed for certain usage scenarios.

Although the controls and content displayed on a touch screen can be flexibly changed, one disadvantage of such touch screens is that the surface of the touch screen is flat and does not provide tactile feedback for a user. Drivers therefore cannot typically determine a current selection without looking at the controls. Therefore, users must typically look at the touch screen when operating its controls, which adds risk to the driving process.

### SUMMARY

The present disclosure presents new and innovative methods and systems for selecting items on a vehicle touch screen. In one embodiment, a method for selecting an item on a vehicle touch screen is provided comprising determining, upon detection of an external touch operation, (i) an initial touch position of the external touch operation and (ii) an option selection control and an initial option selection of the option selection control corresponding to the initial touch position; detecting a current touch position and a movement trajectory of the external touch operation; determining a focused option corresponding to the current touch position and the movement trajectory; detecting a termination of the external touch operation; determining a final disengagement location of the external touch operation based, at least in part, on the movement trajectory; and determining a final selection based on the initial touch position, the final disengagement position, and the movement trajectory.

In another embodiment, determining the focused option corresponding to the current touch position and the movement trajectory further comprises determining whether the current touch position is within a coverage area of an option of the option selection control; responsive to determining that the current touch position is within the coverage area of the option, determining that the option is the focused option; and responsive to determining that the current touch position is not in the coverage area of the option: determining a filter option from among one or more nearby options closest to the current touch position; and determining that the filter option is the focused option.

In a further embodiment, determining the final selection further comprises determining whether the final disengagement position is within a coverage area of an option of the option selection control; responsive to determining that the final disengagement position is within the coverage area of the option, determining that the option is the final selection; and responsive to determining that the final disengagement position is not within the coverage area of the option: determining a target option from among one or more nearby options closest to the current touch position; and determining that the target option is the final selection.

In yet another embodiment, the method further comprises determining that the current touch position remains still for longer than a predetermined period of time; and providing audio feedback of text content corresponding to the focused option.

In a still further embodiment, the method further comprises receiving a vocal feedback trigger gesture; and entering a vocal feedback mode in which audio feedback of text content corresponding to the focused option is provided.

In another embodiment, a vehicle-mounted touch screen is provided comprising a position detection module that determines, upon detection of an external touch operation, (i) an initial touch position of the external touch operation and (ii) an option selection control and an initial option selection of the selection control option corresponding to the initial touch position; a focus determination module that detects a current touch position and a movement trajectory of the external touch operation and determines a focused option corresponding to the current touch position and the movement trajectory; a position determination module that detects a termination of the external touch operation and determines a final disengagement location of the external touch operation based, at least in part, on the movement trajectory; and an option determination module that determines a final selection based on the initial touch position, the final disengagement position, and the movement trajectory.

In a further embodiment, the focus determination module includes a first determination unit that determines whether the current touch position is within a coverage area of an option of the option selection control and, responsive to determining that the current touch position is within the coverage area of the option, determines that the option is the focused option; and a first calculation unit that, responsive to the first determination unit determining that the current touch position is not within the coverage area of the option, (i) determines a filter option from among one or more nearby options closest to the current touch position and (ii) determines that the filter option is the focused option.

In yet another embodiment, the option determination module includes a second determination unit that determines whether the final disengagement position is within a coverage area of an option of the option selection control and, responsive to determining that the final disengagement position is within the coverage area of the option, determines that the option is the final selection; and a second calculation unit that, responsive to determining that the final disengagement position is not within the coverage area of the option, (i) determines a target option from among one or more nearby options closest to the current touch position and (ii) determines that the target option is the final selection.

In a still further embodiment, the focus determination module further determines that the current touch position remains still for longer than a predetermined period of time and provides audio feedback of text content corresponding to the focused option.

In another embodiment, the in-vehicle touch screen further includes an audio feedback module that receives a vocal feedback trigger gesture and enters a reading mode in which the voice broadcast module provides audio feedback of text content corresponding to the current touch position.

In a further embodiment, a system is provided comprising a processor; and a memory storing instructions which, when executed by the processor, cause the processor to: determine, upon detection of an external touch operation, (i) an initial touch position of the external touch operation and (ii) an option selection control and an initial option selection of the option selection control corresponding to the initial touch position; detect a current touch position and a movement trajectory of the external touch operation; determine a focused option corresponding to the current touch position and the movement trajectory; detect a termination of the external touch operation; determine a final disengagement location of the external touch operation based, at least in part, on the movement trajectory; and determine a final selection based on the initial touch position, the final disengagement position, and the movement trajectory.

In yet another embodiment, the memory stores further instructions which, when executed by the processor while determining the focused option corresponding to the current touch position and the movement trajectory, cause the processor to: determine whether the current touch position is within a coverage area of an option of the option selection control; responsive to determining that the current touch position is within the coverage area of the option, determine that the option is the focused option; and responsive to determining the current touch position is not within the coverage area of the option: determine a filter option from among one or more nearby options closest to the current touch position; and determine that the filter option is the focused option.

In a further embodiment, the memory stores further instructions which, when executed by the processor while determining the final selection, cause the processor to determine whether the final disengagement position is within a coverage area of an option of the option selection control; responsive to determining that the final disengagement position is within the coverage area of the option, determine that the option is the final selection; and responsive to determining that the final disengagement position is not within the coverage area of the option: determine a target option from among one or more nearby options closest to the current touch position; and determine that the target option is the final selection.

In yet another embodiment, the memory contains further instructions which, when executed by the processor, cause the processor to: determine that the current touch position remains still for longer than a predetermined period of time; and provide audio feedback of text content corresponding to the focused option.

In a still further embodiment, the memory contains further instructions which, when executed by the processor, cause the processor to receive a vocal feedback trigger gesture; and enter a vocal feedback mode in which audio feedback of text content corresponding to the current touch position is provided.

Compared with the prior art, the present invention has several benefits. When a user needs to choose one of a series of options, the users only has to observe the touch screen once, guide the finger to touch a particular control displayed by the touch screen, and then operate controls and select the final selection with by touch based on auditory feedback based on the movement of their finger. In this process, if a user driver wants to know the content of a current focused option, the user need only stop their finger for a certain period of time and the system will read out the contents of the focused option. The driver can decide whether to select the current focused option without looking at the touch screen. Throughout the process, the driver does not have to look at the touch screen for as long as is required with conventional touch screen controls, which increases driving safety.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

In order to more clearly illustrate the embodiments of the present invention or the technical solutions over the prior art, the drawings used in the embodiments or the description of the prior art will be briefly described below. It is apparent that the drawings in the following description are some embodiments of the present invention, and those skilled in the art can obtain other drawings based on these drawings without any creative work.

FIG. 1 is a schematic diagram of an option selection arrangement in which a total number of options on a touch screen is limited and available screen area is large according to an exemplary embodiment of the present disclosure.

FIG. 2 is a schematic diagram of an option selection arrangement in which the total number of options on the touch screen is limited and available screen area is small according to an exemplary embodiment of the present disclosure.

FIG. 3 is a schematic diagram of an option selection arrangement in which the total number of options on the touch screen is large and available screen area is large according to an exemplary embodiment of the present disclosure.

FIG. 4 is a schematic diagram of an option selection arrangement in which the total number of options on the touch screen is large and available screen area is small according to an exemplary embodiment of the present disclosure.

FIG. 5 is a flowchart of a method for selecting an item on a touch screen according to an exemplary embodiment of the present disclosure.

FIG. 6 is a structural block diagram of a touch screen according to an exemplary embodiment of the present disclosure.

### DETAILED DESCRIPTION OF EXAMPLE EMBODIMENTS

In order to more clearly illustrate the embodiments of the present invention or the technical solutions over the prior art, the drawings used in the embodiments or the description of the prior art will be briefly described below. It is apparent that the drawings in the following description are some embodiments of the present invention, and those skilled in the art can obtain other drawings based on these drawings without any creative work.

In different embodiments according to the present disclosure, option planes and options of different sizes may be utilized for different types of options or touch screens. Additionally, different option selection arrangements utilizing different calculation techniques may be used depending on the situation. Several such situations and arrangements are discussed below.

### Situation 1: Limited Number of Options and Lame Available Screen Area

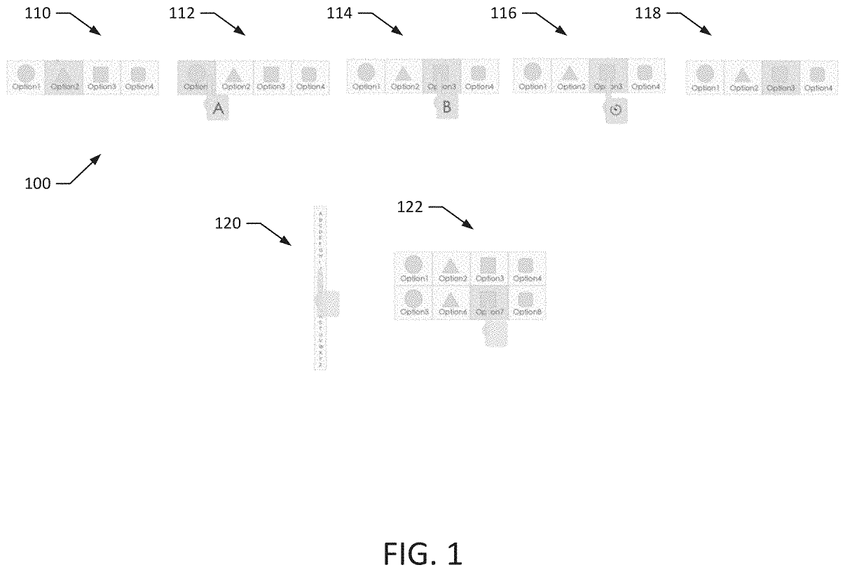

FIG. 1 depicts an option selection arrangement 100 according to an exemplary embodiment of the present disclosure. The option selection arrangement 100 includes options 1-4. In state 110, option 2 is the current focused option, indicated by the darker coloring of the surrounding option area. In state 112, a user touches a finger at position A on the options 1-4 (e.g., on the option 1) to start a selection process.

In state 114, the user's finger moves across the options 1-3 to stop at position B, which points to option 3. The option 3 is accordingly the current focused option, as it is pointed to by the current touch position at position B. As the user's finger moves and the current touch position changes, the focused option may be updated to reflect the option pointed to by at the current touch position. Even if the user's finger moves outside of the bounds of the option selection arrangement 100 the touch screen may continue to track the current touch position.

As shown in state 116, when the user's finger remains in place for more than a predetermined period of time, a speaker may provide audio feedback reflecting text content related to the current focused option so the driver can confirm whether the current focused option is a target of choice by hearing, rather than reading, the content.

As shown in state 118, when the user's finger is lifted from the touch screen the selection process may be complete. The current focused option may then become the final selection and the speaker may read the final selection out loud so that the driver can confirm the correct choice.

FIG. 1 also depicts option selection arrangement 120, 122, where options are arranged in N rows and M columns, where N and M are both positive integers. Such option arrangements 120, 122, may also be appropriate where there are a limited number of options and a large screen area.

### Situation 2: Limited Number of Options and Small Available Area

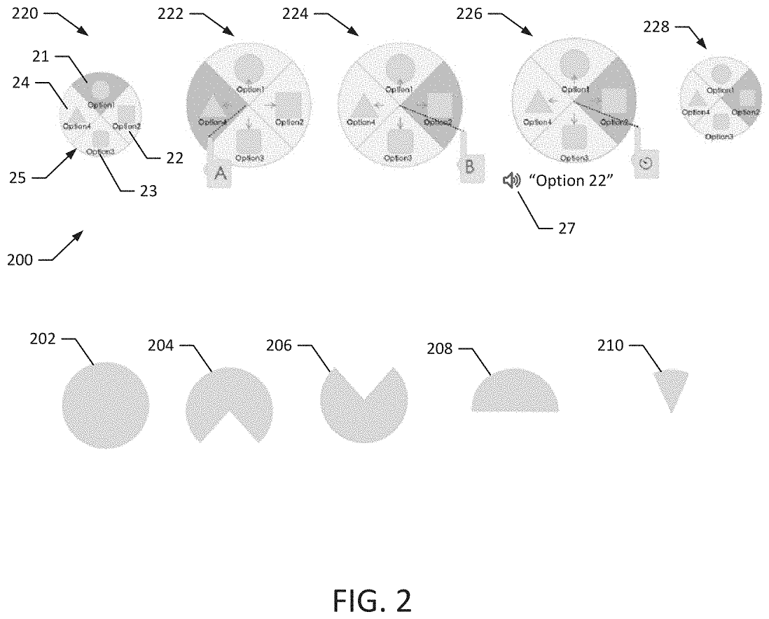

FIG. 2 depicts an option selection arrangement 200 according to an exemplary embodiment of the present disclosure. The option selection arrangement 200 includes an option selection control 25, which is depicted as a 360-degree full circle, but which may also be implemented as a partial circle, as shown with option selection controls 202-210. The option selection arrangement 200 includes options 21-24 arranged within the option selection control 25. The options 21-24 and the option selection control 25 are numbered in state 220, but for simplicity are not numbered in states 222-228. It should be understood that subsequent discussions of these references numbers in the states 222-228 refer to the same portions of the option selection arrangement 200. In state 220, the option 21 is a currently selected option, indicated by the darker coloration surrounding it within the option selection control 25. In implementations where the option selection control 25 is implemented as a partial circle (e.g., the option selection controls 202-210), N options may be assigned to the option selection control.

In state 222, the user's finger touches the touch screen at position A. Once this occurs, a current touch position of the user's finger may be determined, as well as a line connecting the current touch point to the center of the option selection control 25. The option 21-24 through which this line passes may be determined to be the current focused position option. In certain implementations, it may be determined whether the current touch position is within a coverage area of an option of the option selection control. If the current touch position is not within the coverage area, a closest option among all the options 21-24 that is closest to the current position current touch position may be determined.

In state 224, a user may move their finger to position B and the focused option 22 may be updated accordingly. Even if the driver's finger moves out of the option selection control 25, the current touch position of the user's finger may continue to be tracked.

In state 226, if the current touch position remains the same for more than a certain period of time, the speaker may provide audio feedback 27 of text content associated with the current focused option 22 so that the driver can know what the current focused option 22 is without having to keep looking at the option selection control 25.

In state 228, when the user's finger is removed from the touch screen, the selection process may end. At this point, the focused option 22 may become the final selection and the speaker may provide audio feedback so that the driver can confirm that the correct choice was made.

### Situation 3: Large Number of Options and Large Available Area

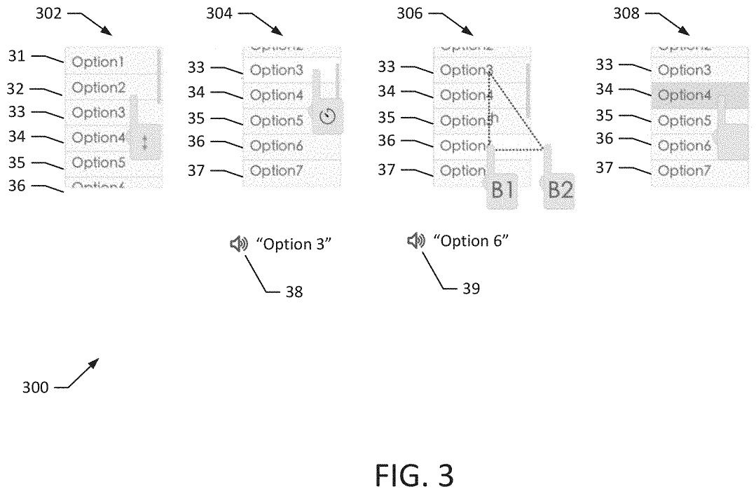

FIG. 3 depicts an option selection arrangement 300 according to an exemplary embodiment of the present disclosure. The option selection arrangement 300 takes up a large area to display many options 31-37. A user may use their finger to touch the control and may move their finger up and down to scroll up and down through the options 31-37 so that more options can be seen.

In state 304, the user may utilize a vocal feedback trigger gesture. The vocal feedback trigger gesture may be two, three, or four fingers touching the touch screen at the same time. If the touch screen is pressure sensitive, a pressure interval can also be defined, (e.g., the vocal feedback trigger gesture may include a finger touching the touch screen with a pressing pressure corresponding to the pressure interval). The vocal feedback trigger threshold may also be defined with a time threshold such that when there is one or more fingers touching the touch screen for longer than the time threshold, the vocal feedback trigger gesture is completed.

When the user completes the vocal feedback trigger gesture, a reading mode may be entered. In the reading mode, options 31-37 pointed to by the current touch position may become the focused option and the speaker may provide audio feedback 38 regarding the focused option 33. This allows the user to understand the current focused option without looking at the touch screen. When the user's finger leaves the touch screen, the system exits waiting mode and the selection option may be completed

As shown in state 306, when the user moves their finger, it may only cause the focused option to change. Regardless of whether the finger continues to move within the control area (position B1) or outside of the control area (position B2), the system may continue to track current touch position and correspondingly update the focused option and provide audio feedback 39.

As shown in 308, the user may select a selected item in multiple ways. First, in the vocal feedback mode, when the user's finger leaves the touch screen, the current focused option may be selected as the selected item. Second, in a waiting reading mode, when the user's finger leaves the screen and uses two, three, or four fingers to quickly touch the touch screen twice (or more times) at any position on the touch screen to select the current focused option. Third, when the user's finger touches an option on the list, the touched option may be selected. When the selection operation is complete, the speaker may also provide audio feedback regarding the selected option so that the user can confirm that the correct selection is made. In certain implementations, all three methods may be used, or only one or two of the methods may be used.

### Situation 4: Lame Number of Options and Small Available Area

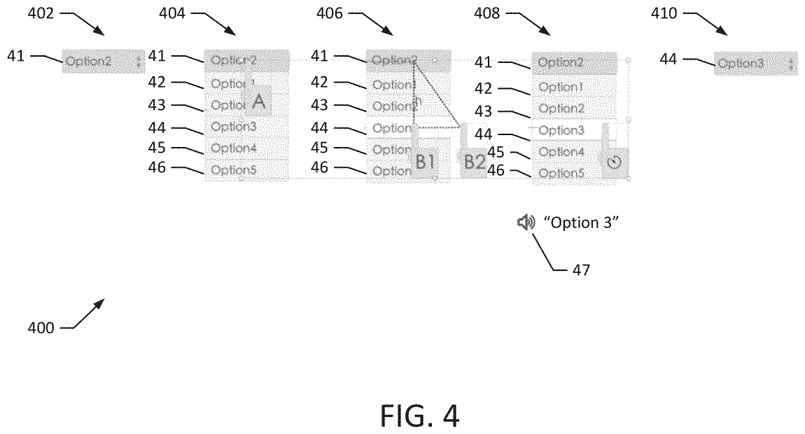

FIG. 4 depicts an option selection arrangement 400 according to an exemplary embodiment of the present disclosure. In the initial state 402, the option 41 is the current selected option. In state 404, a user may touch the control so that all options 41-46 are displayed (either horizontally or vertically).

In sate 406, the user may move their finger and the vertical distance h from the current touch point to the initial touch position (position A) may be continuously tracked, regardless of whether the current touch position is still within the control (position B1) or outside of the control (position B2). The focused option may be selected as the option 41-46 at the same vertical distance from the initial touch position A as the current touch position. The corresponding option 44 may then be calculated and may become the focused option. It may also be determined whether the current touch position is within the coverage area of an option 41-46. If not, a closest option of the options 41-46 may be determined that is closest to the current touch position. This may be implemented so that the most recent option serves as the focused option.

As shown in state 408, if the current touch position remains the same for more than a predetermined period of time, the speaker may provide audio feedback 47 of text content associated with the current focused option so that the user can determine the current focused option without having to look at the touch screen.

In state 410 when the user's finger no longer touches the touch screen, the selection process may end and the focused option 44 may be set as the final selection. In certain implementations, the speaker may provide audio feedback of the selected option 44 so the driver can confirm that the correct selection is made without having to look at the touch screen.

Similar techniques to those discussed above in connection with the option selection arrangements 100, 200, 300, 400 may be applied with for multiple option selection controls on the same interface of a touch screen. For example, the same touch screen interface may include two independent option selection controls similar to the option selection arrangement 200 (e.g., two option selection controls having four options). In such implementations, the initial touch position may be used to determine which option selection control is operated by the touch position, and option selection control that is initially touched by the initial touch position may determine the option selection control that is manipulated. Similar techniques may apply to distinguish between multiple option selection controls of different types.

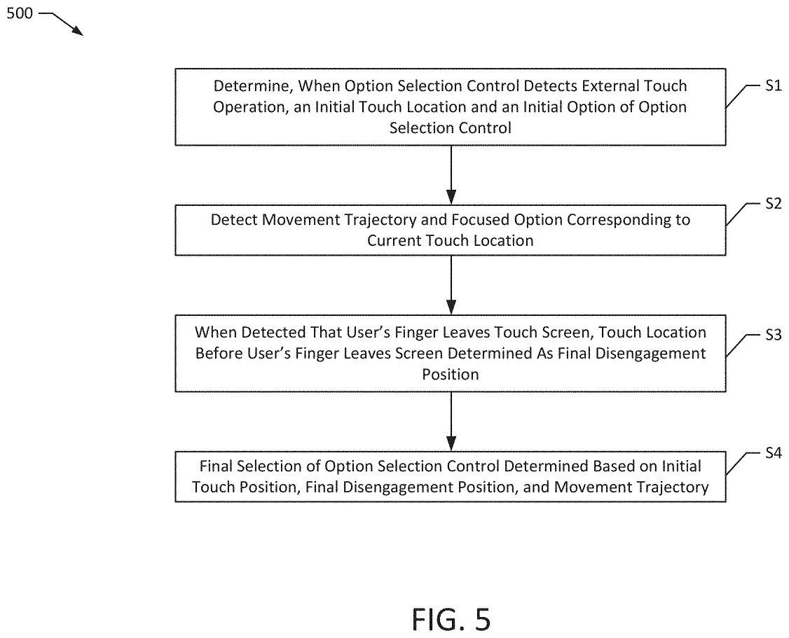

FIG. 5 depicts a method 500 for selecting an item based on a vehicle touch screen. The method 500 may begin with determining, when an option selection control detects an external touch operation, an initial touch position of the external touch operation and an initial option of the option selection control corresponding to the initial touch position (step S1). Then, a movement trajectory of the touch position may be detected and a focused option corresponding to a current touch position may be determined (step S2). When it is detected that a user's finger leaves the touch screen, a touch position before the user's finger leaves the touch screen may be determined according to the movement trajectory as a final disengagement position (step S3). A final selection of the option selection control may then be determined based on the initial touch position, the final disengagement position, and the movement trajectory (step S4).

In certain implementations, performing the step S2 of the method 500 may include additional steps. In particular, performing the step S2 may include determining whether the current touch position in the movement trajectory is within a coverage are of a certain option of the option selection control. If so, the option in which the current location is located may serve as the focused option (step M1). Otherwise, a filter option from among all the options may be determined that is the closest to the location and the filter option may then be used as the focused option (step M2).

In such embodiments, a vertical distance to each of the options may be measured from the current touch positions and the shortest vertical distance from the current touch position may be considered the closest distance. If there is no vertical distance between the current touch position and an option, that option may not be considered a focused option.

In certain implementations, performing the step S4 of the method 500 may include additional steps. In particular, performing the step S4 may include determining whether the final disengagement position is within a coverage area of an option. If so, that option may be determined as the final selection (step N1). Otherwise, a target option from among the options that is closest to the final disengagement position may be determined and used as the final selection (step N2).

In such embodiments, a vertical distance to each of the options may be measured from the final disengagement position and the shortest vertical distance from the final disengagement position may be considered the closest distance. If there is no vertical distance between the final disengagement position and an option, that option may not be considered a final selection.

In still further implementations, performing the step S2 of the method 500 may include additional steps. In particular, performing the step S2 may include, when a current touch position remains still for longer than a preset threshold for a corresponding focused option, auditory feedback regarding text content corresponding to the focused option may be broadcast. In certain implementations, the preset threshold may be 0.

In certain embodiments, prior to performing step S1, the method 500 may further include receiving a vocal feedback trigger gesture and entering a vocal feedback mode, where, in vocal feedback mode, text content that corresponds to the current touch position is read. In such embodiments, vocal feedback mode may also be triggered during selection.

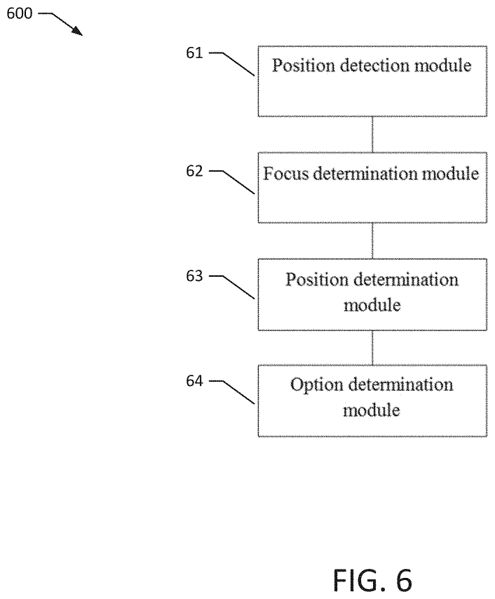

FIG. 6 depicts a vehicle touch screen 600 according to an exemplary embodiment of the present disclosure. The vehicle touch screen 600 includes a position detection module 61 configured to determine, when an option selection control detects an external touch operation, an initial touch position of the external touch operation and an initial option of the option selection control corresponding to the initial touch position. The vehicle touch screen 600 also includes a focus determination module 62 configured to detect a movement trajectory of the touch position and determine a focused option corresponding to a current touch position. The vehicle touch screen 600 further includes a position determination module 63 configured to determine, when it is detected that a user's finger leaves the touch screen, a touch position before the user's finger leaves the touch screen according to the movement trajectory as a final disengagement position. The vehicle touch screen 600 still further includes an option determination module 64 configured to determine a final selection of the option selection control according to the initial touch position, the final disengagement position, and the movement trajectory.

In an example of the invention, the focus determination module 62 includes a first determination unit and a first calculation unit. The first determination unit may be configured to determine whether the current touch position in the movement trajectory is within a coverage area of a certain option. If so, the option in which the current touch position is located may be used as a focused option. Otherwise the focus determination module 62 may trigger the first calculation unit, which may be configured to determine a filter option among the options that is closest to the current touch position as the focused option.

In certain embodiments, the option determination module 64 includes a second determination unit and a second calculation unit. The second determination unit may be configured to determine whether the final disengagement position is within a coverage area of an option. If so, that option may serve as the final selection. Otherwise, the option determination module 64 may trigger the second calculation unit, which may be configured to determine a target option among the options that is closest to the final disengagement position and may use the target option as the final selection.

In certain embodiments, the focus determination module 62 may be further configured to, when the current touch position remains still for a duration exceeding a preset threshold, broadcast auditory feedback reflecting text content corresponding to the focused option corresponding to the current touch position.

In an embodiment of the invention, the vehicle touch screen 600 further includes a voice broadcast module for receiving a vocal feedback trigger gesture and entering a vocal feedback mode. In the vocal feedback mode, text content corresponding to the current touch position may be provided by auditory feedback.

The content of the information exchange, the parameter adjustment process, and the like between the modules 61-64 and other components of the touch screen 600 may be based on the above-discussed methods, including the method 400 and the steps M1-M2 and N1-N2.

It should be noted that, in this context, relational terms such as first and second are used merely to distinguish one entity or operation from another entity or operation, and do not necessarily require or imply any such actual relationship or order between these entities or operations. Furthermore, terms “includes” or “comprises” or “comprises” or any other variation thereof is intended to cover a non-exclusive inclusion, such that a process, method, article, or device comprising a plurality of elements includes not only those elements but also other elements not specifically listed, or it also includes elements inherent to such a process, method, article or device. An element defined by the phrase “includes a . . . ”, without further limitation, does not exclude the presence of additional equivalents in the process, method, article, or device that comprises the element.

Those with ordinary skill in the art can understand that all or part of the steps of implementing the foregoing method embodiments may be performed by hardware related to computer program instructions. The foregoing program instructions may be stored in a computer readable storage medium, and when executed by a processor, the instructions include the steps of the above-discussed methods. Such storage media may include various media that can store program code, such as read-only memory (ROM), random access memory (RAM), disks, optical disks, etc.

The above description focuses primarily on preferred embodiments of the present invention and is only used to explain the technical solutions of the present invention. The description is therefore not intended to limit the scope of the present invention. Any modifications, equivalents, improvements, etc. made within the spirit and scope of the invention are intended to be included within the scope of the invention.

1. A method for selecting an item on a vehicle touch screen, the method comprising:
determining, upon detection of an external touch operation, (i) an initial touch position of the external touch operation and (ii) an option selection control and an initial option selection of the option selection control corresponding to the initial touch position;
detecting a current touch position and a movement trajectory of the external touch operation;
determining a focused option corresponding to the current touch position and the movement trajectory;
detecting a termination of the external touch operation;
determining a final disengagement location of the external touch operation based, at least in part, on the movement trajectory; and
determining a final selection based on the initial touch position, the final disengagement position, and the movement trajectory.

2. The method of claim 1, wherein determining the focused option corresponding to the current touch position and the movement trajectory further comprises:
determining whether the current touch position is within a coverage area of an option of the option selection control;
responsive to determining that the current touch position is within the coverage area of the option, determining that the option is the focused option; and
responsive to determining that the current touch position is not in the coverage area of the option:
determining a filter option from among one or more nearby options closest to the current touch position; and
determining that the filter option is the focused option.

3. The method of claim 1, wherein determining the final selection further comprises:
determining whether the final disengagement position is within a coverage area of an option of the option selection control;
responsive to determining that the final disengagement position is within the coverage area of the option, determining that the option is the final selection; and
responsive to determining that the final disengagement position is not within the coverage area of the option:
determining a target option from among one or more nearby options closest to the current touch position; and
determining that the target option is the final selection.

4. The method of claim 1, further comprising:
determining that the current touch position remains still for longer than predetermined period of time; and
providing audio feedback of text content corresponding to the focused option.

5. The method of claim 1, further comprising:
receiving a vocal feedback trigger gesture; and
entering a vocal feedback mode in which audio feedback of text content corresponding to the focused option is provided.

6. A vehicle-mounted touch screen comprising:
a position detection module that determines, upon detection of an external touch operation, (i) an initial touch position of the external touch operation and (ii) an option selection control and an initial option selection of the selection control option corresponding to the initial touch position;
a focus determination module that detects a current touch position and a movement trajectory of the external touch operation and determines a focused option corresponding to the current touch position and the movement trajectory;
a position determination module that detects a termination of the external touch operation and determines a final disengagement location of the external touch operation based, at least in part, on the movement trajectory; and
an option determination module that determines a final selection based on the initial touch position, the final disengagement position, and the movement trajectory.

7. The vehicle-mounted touch screen of claim 6, wherein the focus determination module includes:
a first determination unit that determines whether the current touch position is within a coverage area of an option of the option selection control and, responsive to determining that the current touch position is within the coverage area of the option, determines that the option is the focused option; and
a first calculation unit that, responsive to the first determination unit determining that the current touch position is not within the coverage area of the option, (i) determines a filter option from among one or more nearby options closest to the current touch position and (ii) determines that the filter option is the focused option.

8. The vehicle-mounted touch screen of claim 1, wherein the option determination module includes:
a second determination unit that determines whether the final disengagement position is within a coverage area of an option of the option selection control and, responsive to determining that the final disengagement position is within the coverage area of the option, determines that the option is the final selection; and
a second calculation unit that, responsive to determining that the final disengagement position is not within the coverage area of the option, (i) determines a target option from among one or more nearby options closest to the current touch position and (ii) determines that the target option is the final selection.

9. The vehicle-mounted touch screen of claim 6, wherein the focus determination module further determines that the current touch position remains still for longer than a predetermined period of time and provides audio feedback of text content corresponding to the focused option.

10. The vehicle-mounted touch screen of claim 6, wherein the in-vehicle touch screen further includes an audio feedback module that receives a vocal feedback trigger gesture and enters a reading mode in which the voice broadcast module provides audio feedback of text content corresponding to the current touch position.

11. A system comprising:
a processor; and
a memory storing instructions which, when executed by the processor, cause the processor to:
determine, upon detection of an external touch operation, (i) an initial touch position of the external touch operation and (ii) an option selection control and an initial option selection of the option selection control corresponding to the initial touch position;
detect a current touch position and a movement trajectory of the external touch operation;
determine a focused option corresponding to the current touch position and the movement trajectory;
detect a termination of the external touch operation;
determine a final disengagement location of the external touch operation based, at least in part, on the movement trajectory; and
determine a final selection based on the initial touch position, the final disengagement position, and the movement trajectory.

12. The system of claim 11, wherein the memory stores further instructions which, when executed by the processor while determining the focused option corresponding to the current touch position and the movement trajectory, cause the processor to:
determine whether the current touch position is within a coverage area of an option of the option selection control;
responsive to determining that the current touch position is within the coverage area of the option, determine that the option is the focused option; and
responsive to determining the current touch position is not within the coverage area of the option:
determine a filter option from among one or more nearby options closest to the current touch position; and
determine that the filter option is the focused option.

13. The system of claim 11, wherein the memory stores further instructions which, when executed by the processor while determining the final selection, cause the processor to:
determine whether the final disengagement position is within a coverage area of an option of the option selection control;
responsive to determining that the final disengagement position is within the coverage area of the option, determine that the option is the final selection; and
responsive to determining that the final disengagement position is not within the coverage area of the option:
determine a target option from among one or more nearby options closest to the current touch position; and
determine that the target option is the final selection.

14. The system of claim 11, wherein the memory contains further instructions which, when executed by the processor, cause the processor to:
determine that the current touch position remains still for longer than a predetermined period of time; and
provide audio feedback of text content corresponding to the focused option.

15. The system of claim 11, wherein the memory contains further instructions which, when executed by the processor, cause the processor to:
receive a vocal feedback trigger gesture; and
enter a vocal feedback mode in which audio feedback of text content corresponding to the current touch position is provided.
